(19) United States
(12) Patent Application Publication
(10) Pub. No.: US 2006/0074519 A1
(43) Pub. Date: Apr. 6, 2006

(54) Medication accuracy comparison system

(76) Inventors: Kenneth N. Barker, Auburn, AL (US); Elizabeth A. Flynn, Artesia, NM (US)

Correspondence Address: CHASE LAW FIRM L.C, 4400 COLLEGE BOULEVARD, SUITE 130, OVERLAND PARK, KS, 66211, US

(21) Appl. No.: 11/207,646

(22) Filed: Aug. 19, 2005

Related U.S. Application Data
(60) Provisional application No. 60/605,311, filed on Aug. 27, 2004.

(51) Int. Cl. G06F 7/00

(52) U.S. Cl. 700/213

(57) ABSTRACT

The medication administration accuracy of a number of hospitals is compared and reports are produced. Data is received from each of the reporting hospitals including dosage error information and matching characteristics on which the hospitals can be compared. The received data is merged to provide a medication accuracy comparison database, and comparison groups are established based on a predetermined characteristic of each hospital. An accuracy rate is calculated for each hospital, and a report is produced comparing the medication administration accuracy of each reporting hospital with other hospitals in the associated comparison group.

### CROSS REFERENCE TO RELATED APPLICATIONS

This application claims the benefit of prior filed, co-pending Ser. No. 60/605,311, filed Aug. 27, 2004.

### FIELD OF THE INVENTION

The present invention relates to a method and a system for comparing and reporting information, and in particular, to a comparison method and system for reporting the accuracy of medication administration for two or more hospitals.

### BACKGROUND OF THE INVENTION

An observation-based system has been developed for detecting medication administration errors and thus determining the percentage of correct doses which are administered at a hospital. The system, called AU Meds (Auburn University Medication Error Detection System), is used by hospitals to measure medication administration errors. Every dose administered during a study period is examined by an independent trained observer, such as a hospital nurse. The observer accompanies a nurse from a selected nursing unit at a hospital during a peak workload period. The observer witnesses the nurse as she prepares and gives medication. After the peak workload period of 8 a.m. until noon, for example, the observer reviews the patients' charts to identify and record discrepancies. The observer then meets with the observed nurse to validate discrepancies as errors and to enlist the nurse's help in seeking clues to the causes of the errors.

All errors are regarded as system defects reflecting defective outcomes of the medication distribution system. The root causes may lie anywhere in the system and not necessarily with the nurse observed. The error rate associated with each individual nurse is kept confidential.

In order to understand medication errors it is important to distinguish one type of error from another. Basically, a medication error is a discrepancy between the dose ordered and the dose received. A medication error occurs under one of the following conditions, for example: omission error—the failure to give an ordered dose; extra dose error; wrong dose error—an amount of medication is given that differs from that ordered by more than 17% (10% for injectables); unordered drug error—a medication is administered that was never ordered for that patient; wrong form error—a dose was given in a different form than ordered; wrong time error—administration of a dose more than 30 minutes before or after it is due; wrong route error—a medication is administered using a different route than was ordered; deteriorated drug error—the drugs are expired, or physical or chemical integrity of a medication's dosage form has been compromised; wrong rate of administration error—infusions or intravenous fluids are administered at a rate other than that which was prescribed; wrong administration technique error, such as failing to wipe an injection site with alcohol prior to administering an injection; and wrong dose preparation error, such as administering an oral suspension without shaking the container.

A number of these medication errors are identified in the AU Meds system. The observer records the observations including errors in the AU Meds software database. The AU Meds software may then be used to tabulate and format the data into reports using Microsoft Access and PowerPoint to graphically provide several layers of analysis which are used to help identify the clues to the causes of discrepancies. These reports may be used by the nursing staff, the pharmacy and therapeutics committee, risk managers and hospital executives.

However, reports provided by the AU Meds software are limited to analysis of data from a single hospital or an installation within a hospital. Reporting capability or comparison with other installations or other hospitals is not provided. There is a need for a system to combine AU Meds data from other hospitals to compare the performance of a hospital with selected peer hospitals.

### SUMMARY OF THE INVENTION

In one aspect of the present invention the aforementioned need is addressed by providing a method of comparing the medication administration accuracy of a number of hospitals. Data is received from each of the hospitals including dosage error information and matching characteristics on which the hospitals can be compared. The received data is merged to provide a medication accuracy comparison database, and comparison groups are established based on a predetermined characteristic of each hospital. An accuracy rate is calculated for each hospital, and a report is produced comparing the medication administration accuracy of each reporting hospital with other hospitals in the associated comparison group.

In another aspect of the present invention, a system is provided for comparing the medication administration accuracy of a number of hospitals and may be accessed via the internet and hosted on a web site. In general, a user of the system may log into a web site which hosts the comparison software employed by the system. The user may be required to select the comparison characteristics which will be used for generating comparison reports. The user then generates a password protected compressed data table from AU Meds software which is transferred to the web site. The data table is merged into a medication accuracy comparison database that includes data from other AU Meds hospital sites. Based on comparison characteristics selected by the user, comparison reports or charts are generated by the medication accuracy comparison system and sent to the user.

### BRIEF DESCRIPTION OF THE DRAWINGS

FIG. 1 is a flowchart of the software in the medication accuracy comparison system that processes the data from participating hospitals.

FIGS. 2-4 are illustrative reports produced by the medication accuracy comparison system in which the matching characteristic is discharges per year.

FIG. 5 is an illustrative report produced by the medication accuracy comparison system in which the matching characteristic is licensed acute care beds.

FIG. 6 is an illustrative report produced by the medication accuracy comparison system in which the matching characteristic is doses billed per year.

### DETAILED DESCRIPTION

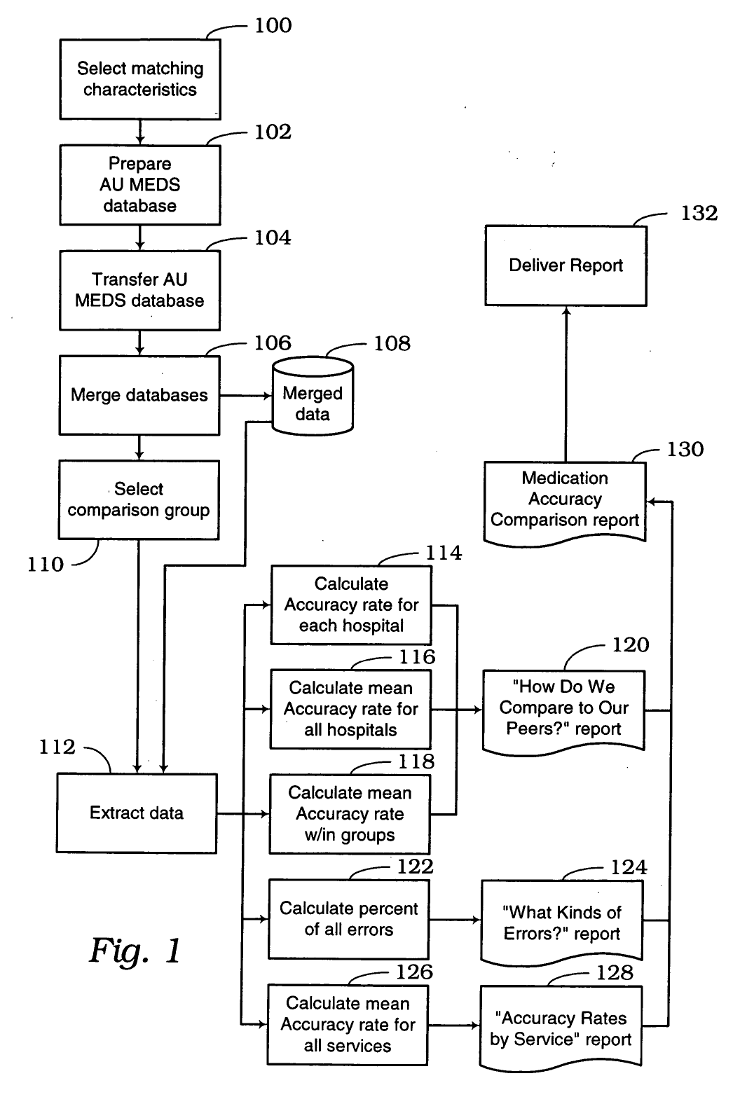

Referring to FIG. 1, at block 100 an AU Meds hospital site selects one or more matching characteristics on which it will be compared with other participating hospitals in a medication accuracy comparison system (MACS) report. For example, hospital characteristics which may be used for this comparison may include the type of facility, whether the hospital is accredited by the Joint Commission on Accreditation of Healthcare Organizations (JCAHO), the number of acute care licensed beds, the number of extended care licensed beds, the total patient days per year, the number of discharges per year, the medication doses billed per year, the type of drug distribution system, whether the hospital uses bar code inspection of medications, who on the hospital staff enters new orders into the computer system, whether a pharmacist reviews and approves new orders before making the drug available, use of the Medication Administration Record (MAR) format, number of days MAR covers, whether a pharmacy-based IV Admixture Service is used to prepare sterile injections, the registered nurse-to-patient ratio, presence of a patient or medication safety officer, use of a particular medication administration model, and definition of wrong time error in plus or minus minutes. One of these characteristics or several in any combination may be selected by the user to generate custom comparison reports tailored to the user's selections.

At a central site, using internet access if desired, the medication accuracy comparison system receives input data from the AU Meds software that creates a compressed data table from the AU Meds database, block 102. The compressed data table may be password-protected and may exclude such patient identifying information as patient name, patient medical record number, and the patient's account number, to protect the privacy of the patient and to ensure compliance with government regulations. The data table is then electronically transferred to the medication accuracy comparison system, block 104.

The compressed data file is received by the medication accuracy comparison system and saved. The file is then uncompressed. The format of the AU Meds-generated file is a Microsoft Access .mdb file which includes a table named “tblTransfer”. The database file is opened and the tblTransfer table is selected. An empty database is created such as data.mdb and tblTransfer is exported as dataxxx, where xxx is a hospital site code, into data.mdb.

The data.mdb file is opened and the dataxxx table is selected and opened in design view. The ID Indexed specification is changed to Yes to allow duplicate ID numbers. A new field “Pat,” for patient, is inserted after the SubField with the following attributes: DataType=Text, Field size=4, Required=No, Allow Zero length=Yes, and Indexed=No. A new field “MR,” for medical record, is inserted after Pat with the following attributes: DataType=Text, Field size=25, Required=No, Allow Zero length=Yes, Indexed=No. Another new field “Acct,” for the patient's account number, is inserted after MR with the following attributes: DataType=Text, Field size=25, Required=No, Allow Zero Length=Yes, and Indexed=No. The design changes are then saved and the file is saved.

Next all tblTransfer tables received from hospital sites are imported into the data.mdb file, block 106. The data.mdb database is recreated each time a tblTransfer table is received from a site in order to ensure that any data entry changes from the site are captured. All of the transferred tables are merged into the data.mdb file. Once all the tables are merged into the data.mdb file, the database is saved and Access is closed. The data.mdb file now contains the merged data for the medication accuracy comparison system, block 108.

Next the medication accuracy comparison software is started and a subject hospital site is selected for comparison to a group or groups of other hospitals 110. Data is extracted (block 112) from data.mdb (block 108) to create medication accuracy comparison reports as described below. For example, the extracted data may include hospital code, medical service for each dose, and dose category, e.g., no error, wrong dose, wrong time, unauthorized drug, wrong form, wrong technique, extra dose, omission, and wrong route. All doses (errors and non-errors) are selected to create the reports which are preferably in the form of PowerPoint slides.

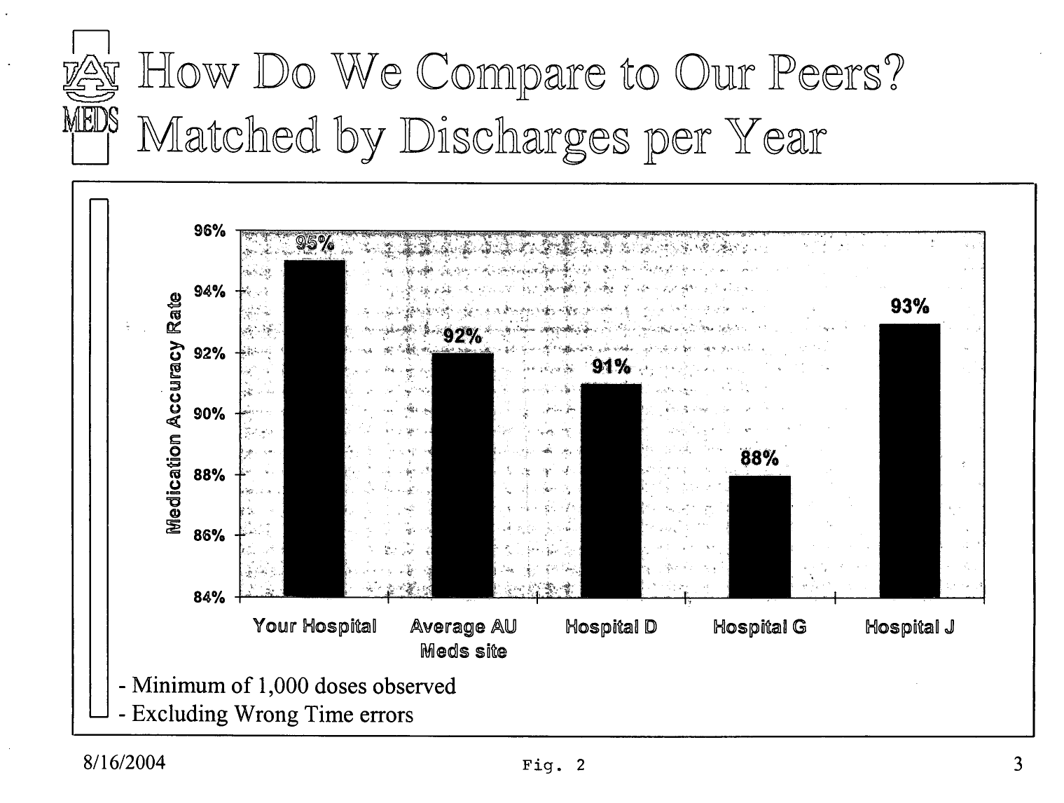

For a peer comparison slide (FIG. 2), the number of no-error doses is divided by the total number of doses observed for each hospital to calculate the accuracy rate for each hospital, block 114. The mean accuracy rate is calculated for all of the AU Meds hospitals, block 116. The mean accuracy rate is calculated for all AU Meds hospitals within each comparison group, block 118. The data for these calculations is output to Microsoft PowerPoint and the medication accuracy comparison slide for peer comparison is generated, block 120, as shown in FIG. 2. The comparison group represented in FIG. 2, for example, may comprise hospitals with discharges per year from 20,000 to 25,000 and a minimum of 1,000 doses observed, with wrong time errors excluded. Ninety-two percent is the average for the group. “Your Hospital” compares favorably at 95%, with selected hospitals D, G & J at 91%, 88% and 93% respectively.

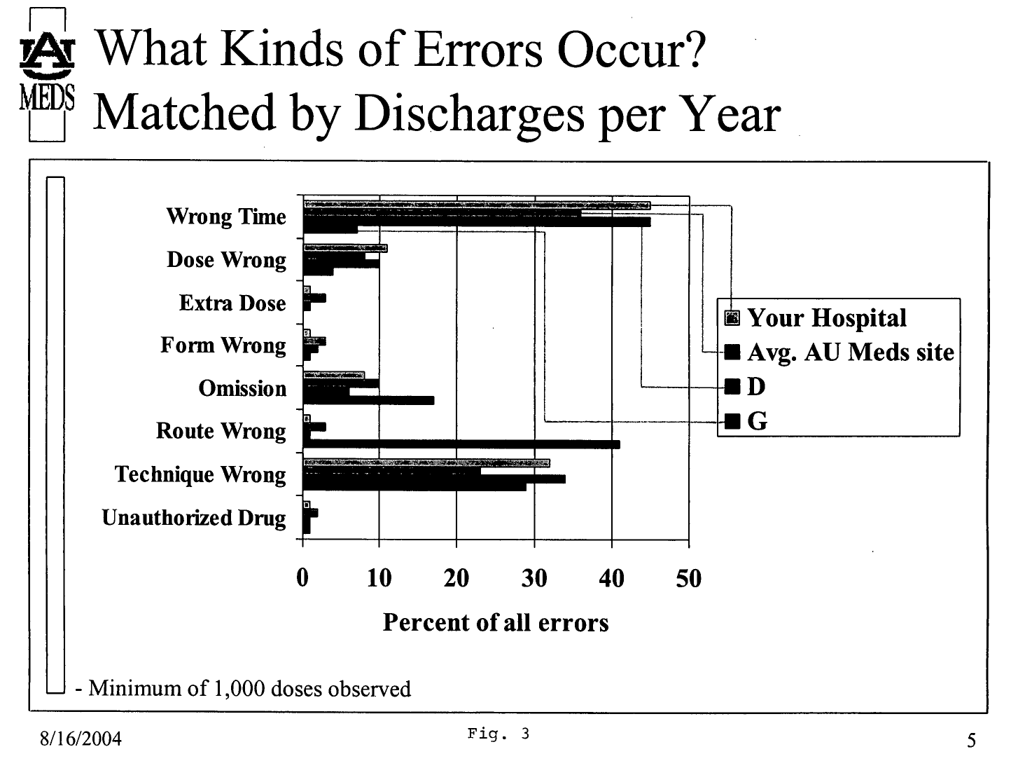

Next, the percent of all errors is calculated by dividing the number of errors in a category by the total number of errors within a hospital (block 122). The data for these calculations is output to Microsoft PowerPoint and the medication accuracy comparison slide for the kinds of errors that occur is generated, block 124, as shown in FIG. 3.

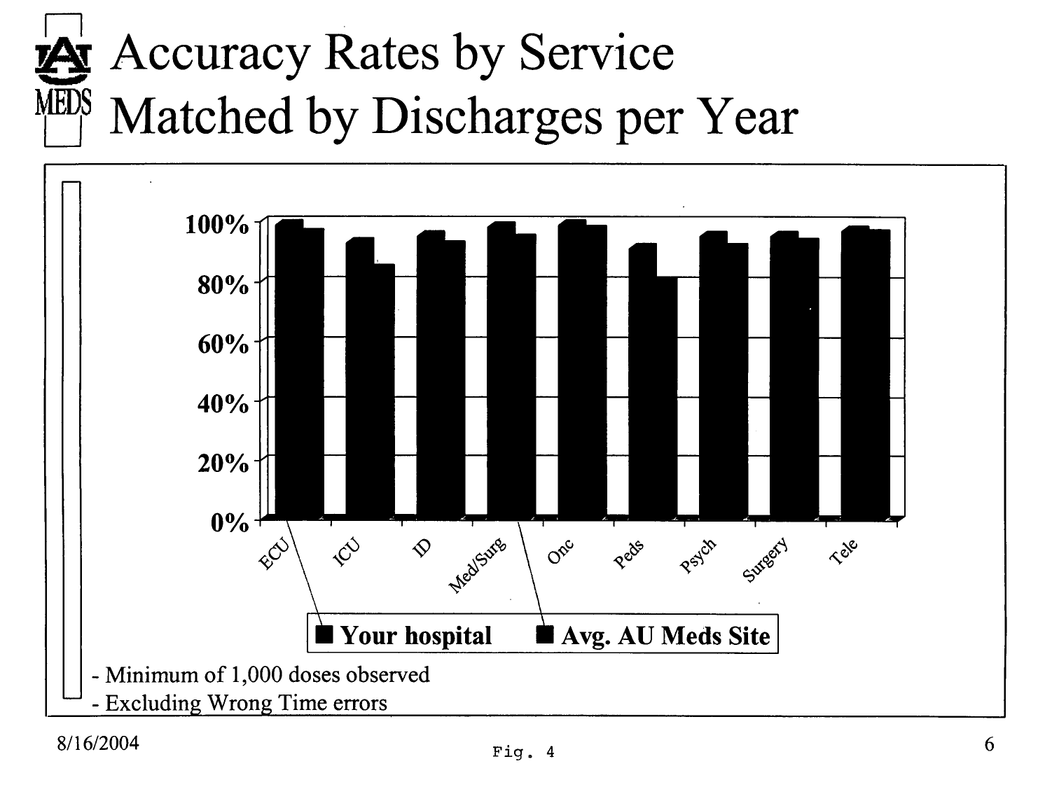

Next, the mean accuracy rate is calculated for each medical service within each AU Meds hospital within each comparison group, block 126. The data for these calculations is output to Microsoft PowerPoint and the medication accuracy comparison slide for the accuracy rates by service is generated, block 128, as shown in FIG. 4.

Next, an executive summary report and a clinical summary report may be created in AU Meds using a respective Crystal Report selected from the SQL screen of the AU Meds software, which are output and combined with the above reports, block 130. The report is saved in PDF format to allow electronic transmission in a format that is readily readable.

Finally, the report may be transmitted to the client electronically as an attachment to an email, by facsimile or by regular mail, block 132.

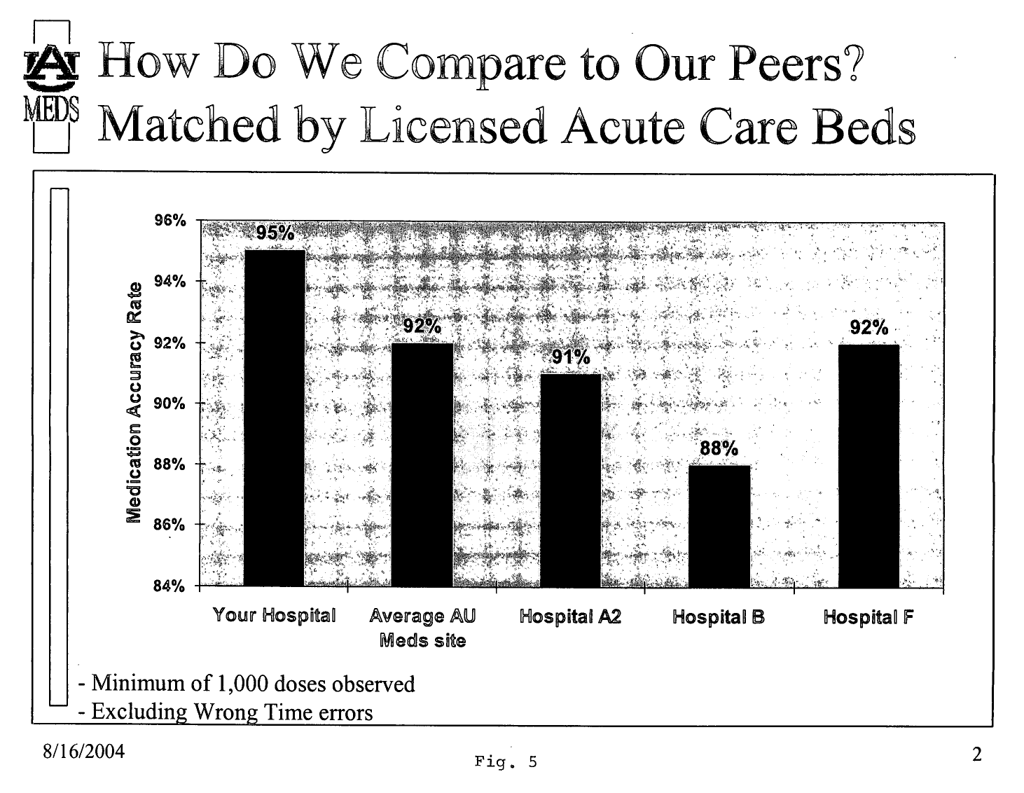

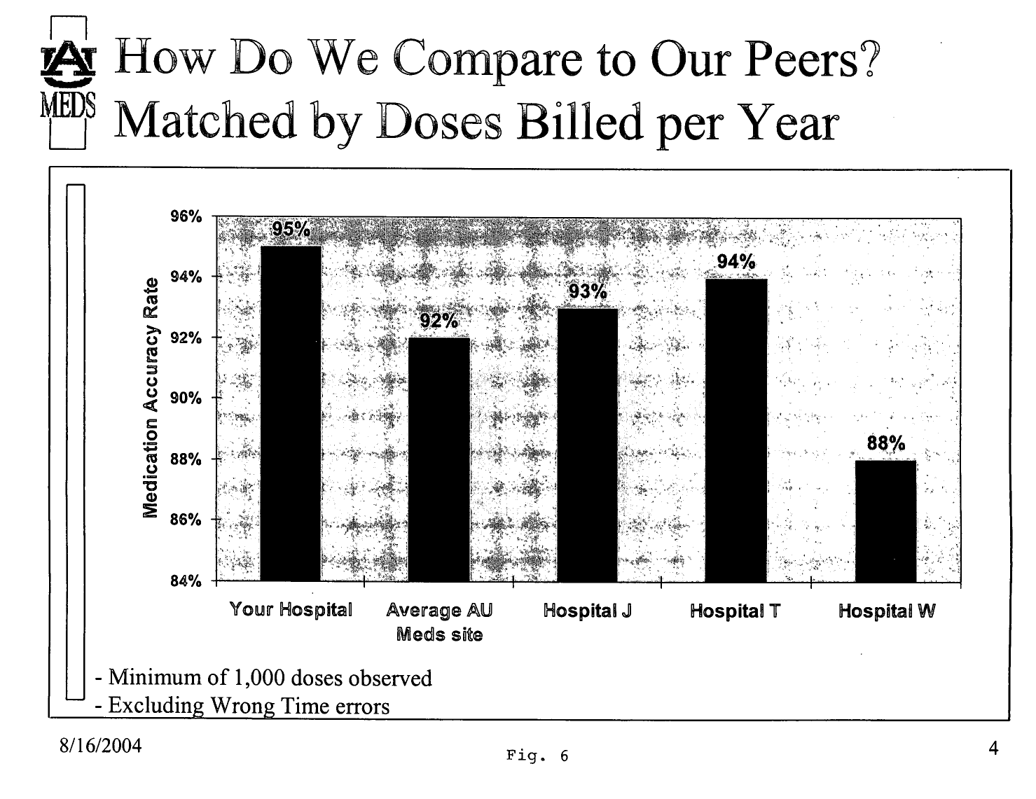

FIGS. 5 and 6 are additional examples of reports that may be produced by the medication accuracy comparison system. Rather than matching by discharges per year as in the reports of FIGS. 2-4, the slide shown in FIG. 5 matches the hospitals by the number of licensed acute care beds comprising a comparison group. The slide of FIG. 6 is a further example in which the comparison is based on doses billed per year. It will be appreciated, therefore, that comparison reports may be tailored to the particular comparison of hospital performance selected by the user.

It is to be understood that while certain forms of an embodiment of this invention have been illustrated and described, it is not limited thereto, except insofar as such limitations are included in the following claims and allowable equivalents thereof.

Having thus described the invention, what is claimed as new and desired to be secured by Letters Patent is:

1. A method of comparing the medication administration accuracy of a number of reporting hospitals, said method including the steps of:
(a) receiving data from each of said hospitals including dosage error information and matching characteristics on which the hospitals can be compared,
(b) establishing a comparison group in response to said data based on a selected matching characteristic of each hospital,
(c) calculating an accuracy rate for each hospital in response to the received dosage error information, and
(d) comparing the medication administration accuracy of each reporting hospital with other hospitals in the comparison group.

2. The method as claimed in claim 1, wherein said step (d) includes producing a comparison report.

3. The method as claimed in claim 1, wherein said dosage error information is selected from the group consisting of wrong dose, wrong time, unauthorized drug, wrong form, wrong technique, extra dose, omission, and wrong route.

4. The method as claimed in claim 1, wherein said selected matching characteristic of each hospital is selected from the group consisting of the type of facility, hospitals that are accredited, number of acute care licensed beds, number of extended care licensed beds, number of total patient days per year, number of discharges per year, medication doses billed per year, type of drug distribution system utilized, hospitals that utilize bar code inspection of medications, hospitals in which new orders are entered into the computer system by a hospital staff member, hospitals in which a pharmacist approves new orders before making a drug available, hospitals that use the Medication Administration Record format, hospitals that use a pharmacy-based IV Admixture Service, registered nurse-to-patient ratio, hospitals that utilize a safety officer, hospitals that use a medication administration model, and hospitals that define wrong time error in plus or minus minutes.

5. A method of comparing the medication administration accuracy of a number of reporting hospitals, said method including the steps of:
(a) receiving data from each of said hospitals including dosage error information and matching characteristics on which the hospitals can be compared,
(b) establishing comparison groups in response to said data based on selected matching characteristics of each hospital,
(c) calculating an accuracy rate for each hospital in response to the received dosage error information, and
(d) producing a report comparing the medication administration accuracy of each reporting hospital with other hospitals in a selected comparison group.

6. The method as claimed in claim 5, wherein said dosage error information is selected from the group consisting of wrong dose, wrong time, unauthorized drug, wrong form, wrong technique, extra dose, omission, and wrong route.

7. A method of comparing the medication administration accuracy of a number of reporting hospitals, said method including the steps of:
(a) receiving data from each of said hospitals including dosage error information and matching characteristics on which the hospitals can be compared,
(b) merging the received data to provide a medication accuracy comparison database,
(c) selecting a matching characteristic from said database common to each of the reporting hospitals,
(d) establishing a comparison group based on said selected matching characteristic of each hospital,
(e) calculating an accuracy rate for each hospital in response to the received dosage error information, and
(f) producing a report comparing the medication administration accuracy of each reporting hospital with other hospitals in the comparison group.

8. The method as claimed in claim 7, wherein said dosage error information is selected from the group consisting of wrong dose, wrong time, unauthorized drug, wrong form, wrong technique, extra dose, omission, and wrong route.

9. The method as claimed in claim 7, wherein said selected matching characteristic of each hospital is selected from the group consisting of the type of facility, hospitals that are accredited, number of acute care licensed beds, number of extended care licensed beds, number of total patient days per year, number of discharges per year, medication doses billed per year, type of drug distribution system utilized, hospitals that utilize bar code inspection of medications, hospitals in which new orders are entered into the computer system by a hospital staff member, hospitals in which a pharmacist approves new orders before making a drug available, hospitals that use the Medication Administration Record format, hospitals that use a pharmacy-based IV Admixture Service, registered nurse-to-patient ratio, hospitals that utilize a safety officer, hospitals that use a medication administration model, and hospitals that define wrong time error in plus or minus minutes.
